(19) United States
(12) Patent Application Publication
(10) Pub. No.: US 2009/0323220 A1
(43) Pub. Date: Dec. 31, 2009

(54) HEAD ARM ASSEMBLY, INFORMATION STORAGE DEVICE AND SUSPENSION

(75) Inventor: Yukihiro Komura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/390,057

(22) Filed: Feb. 20, 2009

(30) Foreign Application Priority Data
Jun. 27, 2008 (JP) 2008-168998

(51) Int. Cl. G11B 5/60

(52) U.S. Cl. 360/234.6; G9B/5.229

(57) ABSTRACT

A head arm assembly includes: a slider which has a head executing recording and/or reproducing operations of information onto and/or from an information recording medium, and which approaches or comes into contact with the information recording medium, a leaf spring holding the slider at its one end, an arm holding the other end of the leaf spring, provided with a groove at a predetermined position, and a tail extending from the leaf spring in a form of a band, which is provided with a conductive pattern connected to the head along the band, in which a halfway position of the band in a longitudinal direction is mounted in the groove of the arm, one of both edges at the position is directed toward the arm, and the tail has projections and depressions in a widthwise direction of the band on an edge opposite to the arm at the position.

### CROSS-REFERENCE TO RELATED APPLICATION

This application is based upon and claims the benefit of priority of the prior Japanese Patent Application No. 2008-168998, filed on Jun. 27, 2008, the entire contents of which are incorporated herein by reference.

### FIELD

The embodiments discussed herein are related to a head arm assembly which holds a slider having a head which records and reproduces information into and from an information recording medium, and which moves the slider with respect to the information recording medium, to an information storage device having such a head arm assembly, and to a suspension which holds the slider in the head arm assembly.

### BACKGROUND

In the field of computer, a large amount of information is handled on a daily basis. A hard disk drive (HDD) is used as one of information storage devices which record and reproduce a large amount of information. The HDD has characteristics that information recording capacity is large and information access time is fast. The HDD generally includes magnetic disks having surfaces made of magnetic materials, and a head which records and reproduces information into and from the magnetic disks.

FIG. 6 illustrates one example of the HDD.

A HDD 500 illustrated in FIG. 6 is connected to a host device such as a personal computer, or is assembled into the host device.

As illustrated in FIG. 6, accommodated in a housing 501 of the HDD 500 are magnetic disks 600 into which information is recorded and from which information is reproduced, a spindle motor 510 which rotates the magnetic disks 600, a slider 520 (see FIG. 7) having an after-mentioned head which executes the recording and reproduction of information, a head arm assembly 530 which holds the slider 520 and turns the slider 520 around an arm shaft 531 to move the slider 520 with respect to the magnetic disk 600, a voice coil motor 540 which turns the head arm assembly 530, and a control circuit 550 which controls operation of the HDD 500. The head arm assembly 530 includes an arm 532 which is driven by a voice coil motor 540, and a suspension 533 which holds the slider 520 at its leading end. The arm 532 and the suspension 533 are connected to each other through a connection 534.

Conventionally, the exchange of various information set between the heads and the control circuit in the HDD is generally carried out through a wiring pattern formed on a surface of the suspension, a flexible printed circuit (FPC) which electrically connects the arm to the control circuit, and a relay FPC which relays between the wiring pattern and the FPC. To reduce the number of parts in such a structure, a so-called long tail type suspension in which a suspension having a wiring pattern on its surface and the relay FPC are integrally formed have received attention (see Japanese Laid-open Patent Publication Nos. 2005-78688 and 2007-179683 for example).

The suspension 533 in the HDD 500 in FIG. 6 is the long tail type suspension.

FIG. 7 is an enlarged view of the head arm assembly illustrated in FIG. 6.

As illustrated also in FIG. 6, in the head arm assembly 530, the suspension 533 which holds the slider 520 at its leading end is connected to the arm 532 through the connection 534. A head 521 which records and reproduces information is mounted on a leading end of the slider 520. The suspension 533 is of the long tail type, and includes a leaf spring 533a, a wiring pattern 533b formed on a surface of the leaf spring 533a and connected to the head 521, and a long tail 533c which is integrally formed on the leaf spring 533a and extends from the wiring pattern 533b to a FPC 560 illustrated also in FIG. 6 to electrically connect the wiring pattern 533b and the FPC 560 with each other. Conductors forming the wires of the wiring pattern 533b and the long tail 533c are covered with insulation sheets such as polyimide, and include protection members 533b_1 and 533c_1 therein.

In FIG. 7, the long tail 533c of each suspension 533 extends to the FPC 560 through a groove 532a formed in a side surface of the arm 532, and the long tail 533c is adhered and fixed to the arm 532 in the groove 532a through a predetermined adhesive 570. Generally, in a HDD which employs the long tail type suspension, flutter of the long tail caused by flowage of air generated by rotation of the magnetic disk 600 is restrained by the structure illustrated in FIG. 7.

In many cases, in the structure for suppressing the flutter illustrated in FIG. 7, the adhering state at adhering positions of the long tails 533c in the grooves 532a becomes as follows.

FIG. 8 is a schematic cross sectional view of the adhering position of the long tail illustrated in FIG. 7.

As illustrated in FIG. 8, each long tail 533c is inserted between inner wall surfaces of the groove 532a. Therefore, when the adhesive 570 is applied, capillary action occurs between the inner wall surfaces of the groove 532a and the front and back surfaces of the long tails 533c, and non-cured adhesive 570 enters into the deep side of the groove 532a. As illustrated in FIG. 7, the arm 532 sometimes includes two suspensions 533. In such a case, as illustrated in FIG. 8, the two long tails 533c are superposed on each other and accommodated in the groove 532a in this state. At that time, capillary action occurs also between the superposed two long tails 533c, and non-cured adhesive 570 enters further deeply.

Generally, in the HDD, a deteriorated head is often replaced by a new one at the time of repair. The head is replaced in each suspension having the head in many cases, but if an adhesive enters into the deep side in the groove at the adhering position of the long tail as illustrated in FIG. 8, it is very difficult to detach an old suspension and to remove the adhesive from the groove at the time of replacement.

### SUMMARY

According to an aspect of the invention, a head arm assembly includes:

a slider which has a head executing recording and/or reproducing operations of information onto and/or from an information recording medium, and which approaches or comes into contact with the information recording medium,

a leaf spring which holds the slider at its one end,

an arm which holds the other end of the leaf spring and is provided with a groove at a predetermined position, and

a tail which extends from the leaf spring in a form of a band, which is provided with a conductive pattern connected to the head along the band, in which a halfway position of the band in a longitudinal direction is mounted in the groove of the arm, one of both edges at the position is directed toward the arm, and the tail has projections and depressions in a widthwise direction of the band on an edge opposite to the arm at the position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a hard disk drive (HDD) which is a concrete embodiment of an information storage device;

FIG. 2 is an enlarged view of a head arm assembly illustrated in FIG. 1;

FIG. 3 is an enlarged view of adhering positions of a long tail illustrated in FIG. 2;

FIG. 4 is a top view illustrating only the long tail;

FIG. 5 is a schematic sectional view of the adhering positions of the long tail illustrated in FIG. 2;

FIG. 6 illustrates one example of the HDD;

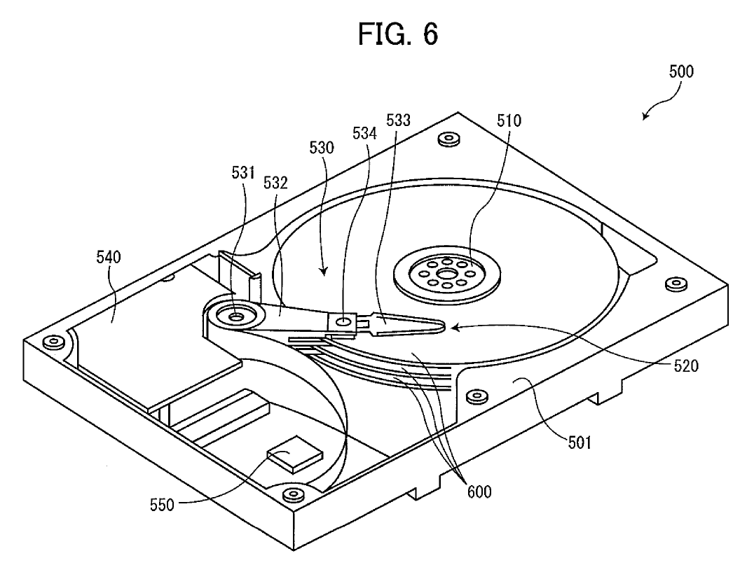

FIG. 7 is an enlarged view of the head arm assembly illustrated in FIG. 6; and

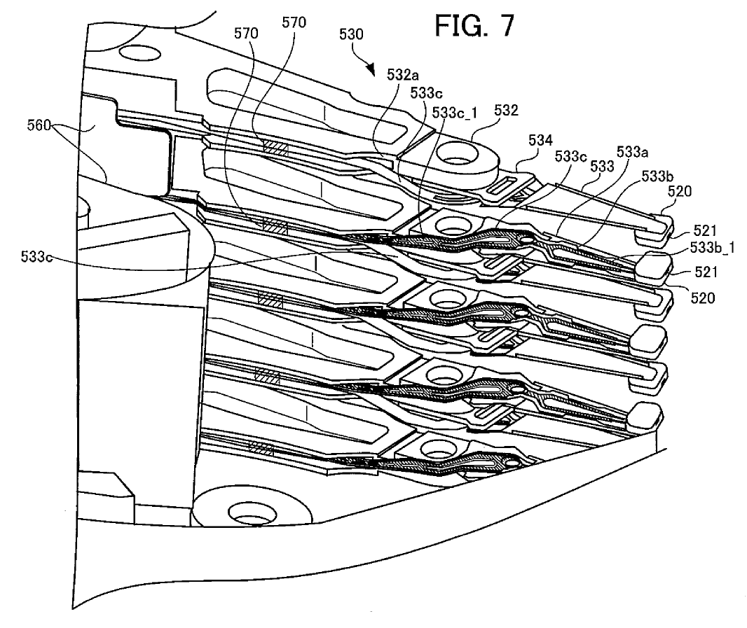

FIG. 8 is a schematic sectional view of the adhering positions of the long tail illustrated in FIG. 7.

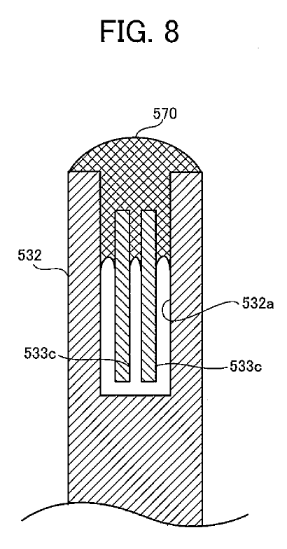

### DESCRIPTION OF EMBODIMENT

A concrete embodiment of the head arm assembly, the information storage device and the suspension described based on the basic mode will be described with reference to the drawings.

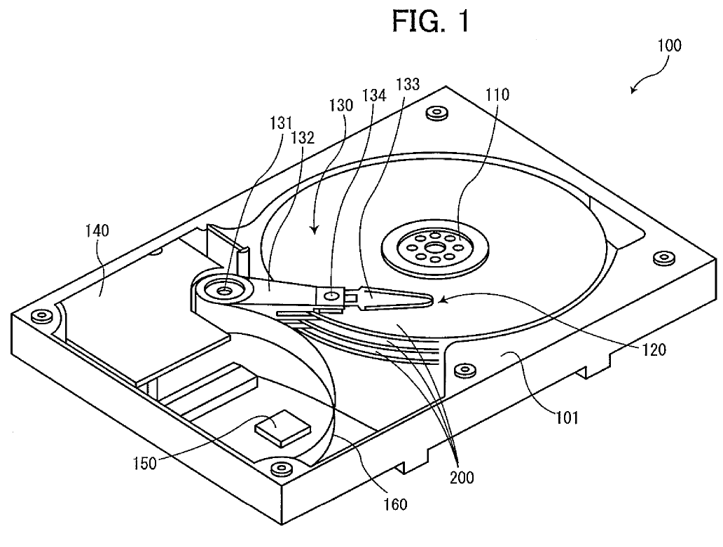

FIG. 1 illustrates a hard disk drive (HDD) which is one example of the information storage device described based on the basic mode.

The HDD 100 illustrated in FIG. 1 is connected to or incorporated in a host device such as a personal computer, and is utilized.

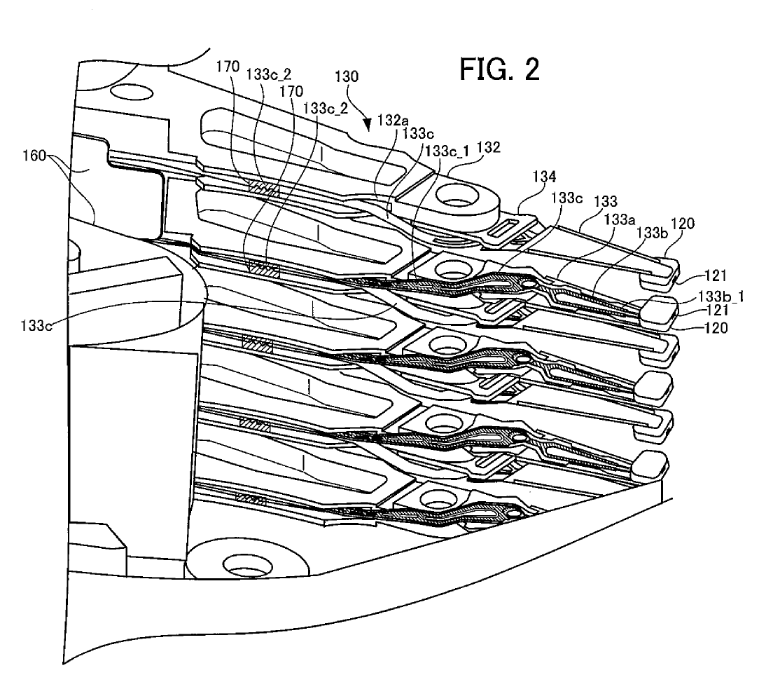

As illustrated in FIG. 1, accommodated in a housing 101 of the HDD 100 are a magnetic disk 200 on which information is recorded and from which information is reproduced, a spindle motor 110 which rotates the magnetic disk 200, a slider 120 (see FIG. 2) having an after-mentioned head which executes the recording and reproducing operations of information, a head arm assembly 130 which holds the slider 120, turns the slider 120 around an arm shaft 131 and moves the slider 120 with respect to the magnetic disk 200, a voice coil motor 140 which turns the head arm assembly 130, and a control circuit 150 which controls the operation of the HDD 100. The HDD 100 records information on the magnetic disk 200 and reads information recorded on the magnetic disk 200 using a magnetic field of a head 120.

The head arm assembly corresponds to one example of the head arm assembly described concerning the basic mode. The magnetic disk 200 corresponds to one example of the information recording medium in the basic modes of the head arm assembly, the information storage device and the suspension. The slider 120 corresponds to one example of a slider in these basic modes.

The magnetic disk 200 is provided at its surface with a linear truck around a rotation shaft of the spindle motor 110, and the truck is divided into regions (sectors) in its circumferential direction. In the HDD 100, a series of logical addresses is allocated to each sector on the magnetic disk 200.

The head arm assembly 130 includes an arm 132 operated by the voice coil motor 140, and suspensions 133 which hold sliders 120 at their leading ends. The arm 132 and the suspension 133 are connected to each other through a connection 134. The arm 132 corresponds to one example of the arm in the basic mode.

Magnetic disks 200 and heads are provided in the HDD 100. The heads execute recording and reproducing operations of information on front and back surfaces of the magnetic disks 200. That is, the HDD 100 is provided with the suspensions 133 on the front and back surfaces of each magnetic disk 200 one each, and the suspension 133 holds the slider 120. Since the suspensions 133 are connected to the arm 132, the sliders 120 are moved as one unit.

When information is written onto the magnetic disk 200, information to be recorded onto the magnetic disk 200 and a logical address of a recording position are sent to the HDD 100 from the host device (not illustrated). The control circuit 150 converts the logical address into a physical address which includes a cylinder number representing which one of trucks provided on the magnetic disk 200, a head number representing which one of the heads 121, and a sector number representing which sector on the truck. The control circuit 150 drives the spindle motor 110 to rotate the magnetic disk 200, drives the voice coil motor 140, and moves the arm 132 to a truck represented by the cylinder number of the physical address. The head mounted on the slider 120 is positioned on a sector represented by the sector number of the physical address by a series of these processing.

When the head mounted on the slider 120 is positioned, writing current carrying information is applied to the head from the control circuit 150.

In the head, a magnetic field of polarity in accordance with the writing current is generated by an embedded coil (not illustrated). As a result, the magnetic field generated by the coil is applied to the magnetic disk 200, magnetization in a direction in accordance with the polarity of the magnetic field is formed in the magnetic disk 200, and information is recorded on the magnetic disk 200.

When information recorded on the magnetic disk 200 is to be read, a logical address of the recording position of the information is sent from the host device to the HDD 100. Thereafter, like the writing operation of information, the spindle motor 110 is driven by the control circuit 150, the magnetic disk 200 is rotated, the voice coil motor 140 is driven, the arm 132 is moved, and the head mounted on the slider 120 is positioned on the magnetic disk 200.

An information producing signal in accordance with a magnetic field generated from the magnetization is generated. The information producing signal is converted into digital data and then, the digital data is sent to the host device through the control circuit 150.

Basically, information is recorded and reproduced onto and from the magnetic disk 200 as described above.

In this embodiment, the suspension 133 is a long tail type suspension, in which a wiring pattern formed on the surface of the suspension and a relay flexible printed circuit (FPC) are integrally formed. The FPC relays between the wiring pattern and the FPC 160 that electrically connects from the arm 132 to the control circuit 150.

FIG. 2 is an enlarged view of the head arm assembly illustrated in FIG. 1.

As illustrated also in FIG. 1, the head arm assembly 130 is constituted in such a manner that the suspension 133 holding the slider 120 at its leading end is connected to the arm 132 through the connection 134. The head 121 which executes the recording and reproducing operations of information is mounted on the leading end of the slider 120.

The head arm assembly 130 illustrated in the enlarged view of FIG. 2 is for accessing both the front and back surfaces of the four magnetic disks 200. The head arm assembly 130 includes five arms 132, four suspensions 133 having heads 121 for accessing front surfaces of the magnetic disks 200, and four suspensions 133 having heads 121 for accessing back surfaces of the magnetic disks 200. The uppermost arm 132 includes one suspension 133 for the front surface of the uppermost magnetic disk 200, the lowermost arm 132 includes one suspension 133 for the back surface of the lowermost magnetic disk 200. The second arm 132 includes two suspensions 133, i.e., the suspension 133 for the back surface of the uppermost magnetic disk 200, and the suspension 133 for the front surface of the second magnetic disk 200. The third and fourth arms 132 also include two suspensions 133 for back and front surfaces.

Each suspension 133 is of the long tail type, and includes a leaf spring 133a, a wiring pattern 133b connected to the head 120 formed on the surface of the leaf spring 133a, and a long tail 133c which is integrally formed on the leaf spring 133a and which extends from the wiring pattern 133b to the FPC 160 illustrated in FIG. 1 to electrically connect the wiring pattern 133b and the FPC 160 with each other. The leaf spring 133a corresponds to one example of the leaf spring of the basic mode, and the long tail 133c corresponds to one example of the tail of the basic mode.

Conductors of the wiring pattern 133b and the long tail 133c constituting wires are coated with insulation sheets such as polyimide, and protection members 133b_1 and 133c_1 for reinforcing the wiring pattern 133b and the long tail 133c are incorporated. The long tail 133c of each suspension 133 extends along the surface of the magnetic disk 200, and is bent toward the FPC 160 at a connecting position with respect to the FPC 160. With the structure illustrated in FIG. 2, the conductors in the wiring pattern 133b and the long tail 133c are protected by the protection members 133b_1 and 133c_1 from external forces, and the number of bending times which applies a load to the conductor in the long tail 133c is restrained.

In this embodiment, each arm 132 is provided at its side surface with a groove 132a which is deeper than the width of the long tail 133c. The long tail 133c of each suspension 133 extends to the FPC 160 through the groove 132a formed in the side surface of the arm 132, and the long tail 133c is adhered and fixed to the arm 132 in the groove 132a by means of a predetermined adhesive 170. With the structure illustrated in FIG. 2, flutter of the long tail 133c caused by flowage of air generated by rotation of the magnetic disk 200 is restrained. In the embodiment, flutter of the long tail 133c is effectively restrained by the groove 132a which is deeper than the width of the long tail 133c.

This means that based on the basic mode, an application mode in which the arm has a groove deeper than the width of the tail as the groove is preferable.

The arm 132 in the embodiment corresponds to one example of the arm in the application mode.

In this embodiment, the projections and depressions 133c_2 provided on an edge of the long tail 133c opposite to the arm 132 at its position mounted in the groove 132a correspond to one example of the projections and depressions in the basic mode.

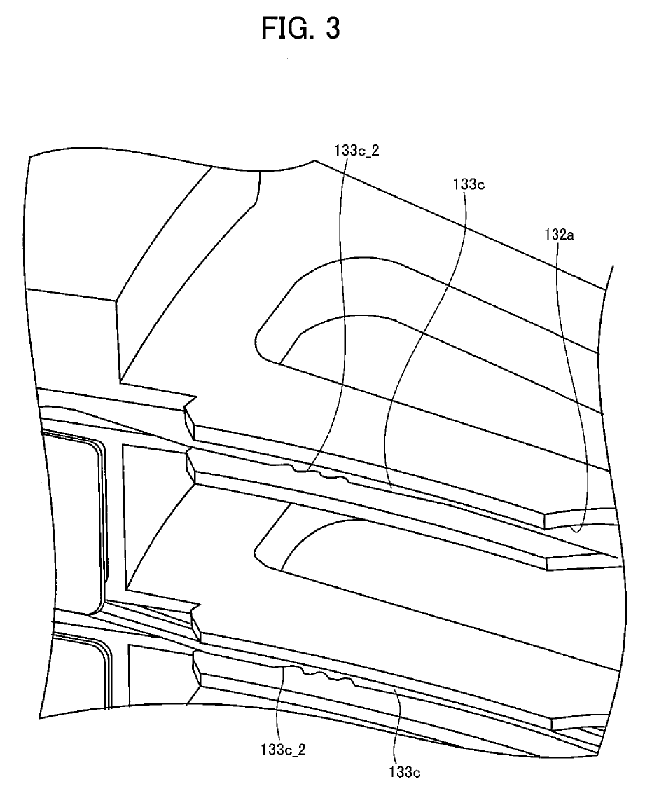

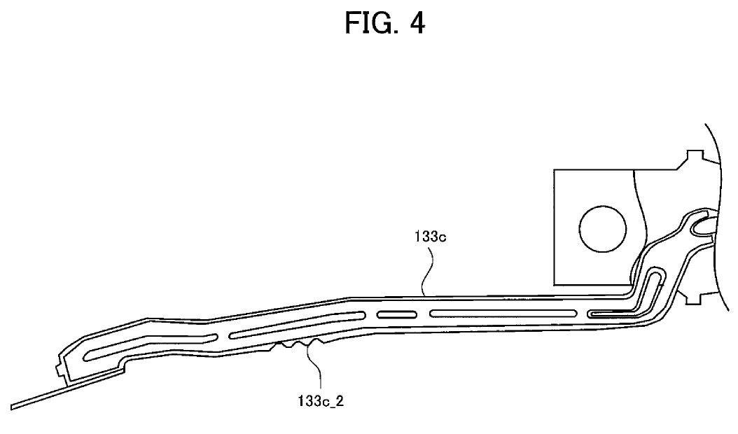

FIG. 3 is an enlarged view of an adhering position of the long tail illustrated in FIG. 2. FIG. 4 is a top view illustrating only the long tail.

In FIG. 3, the adhesive 170 is omitted so that the structure can easily be seen.

As illustrated in FIGS. 3 and 4, in this embodiment, an edge of the long tail 133c facing the outer side of the groove 132a is provided with curved corrugated projections and depressions 133c_2. In this embodiment, in the edge of the long tail 133c facing outer side of the groove 132a, a margin portion of the coating of polyimide or the like with respect to a conductive pattern is wider than an edge opposite to the former edge. In this embodiment, by providing this margin portion with the projections and depressions 133c_2, the projections and depressions 133c_2 are provided without affecting the pattern shape of the inside conductor.

The adhering state of adhering and fixing operations carried out at positions where the projections and depressions 133c_2 are provided is as illustrated in the following drawing.

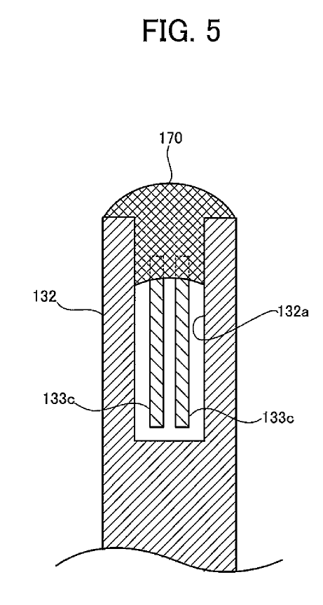

FIG. 5 is a schematic sectional view of the adhered position of the long tail illustrated in FIG. 2.

As illustrated in FIG. 5, each long tail 133c passes through the groove 132a. Therefore, when the adhesive 170 is applied, capillary action occurs between the inner wall surfaces of the groove 132a and the back and front surfaces of the long tails 133c. In the arm 132 having two suspensions 133, two long tails 133c are superposed on each other and accommodated in the groove 132a as illustrated in FIG. 5. In this case, capillary action occurs also between the superposed two long tails 133c.

In this embodiment, however, the adhering and fixing operation is carried out using the adhesive 170 at a position where the projections and depressions 133c_2 is provided on the edge of the long tail 133c facing the outer side of the groove 132a. At the position where the projections and depressions 133c_2 are provided, a surface area is widened due to its shape, and the capillary action is restrained due to a large surface tension caused by the wide surface area. As a result, non-cured adhesive 170 is restrained from entering the groove 132a when the adhesive 170 is applied, and the adhesive 170 is cured in a state where the adhesive 170 stops around the entrance of the groove 132a as schematically illustrated in FIG. 5.

In this embodiment, the projections and depressions 133c_2 have the curved corrugated shape. The smooth curved corrugated shape exhibits a great effect for restraining the capillary action. Therefore, non-cured adhesive 170 is effectively restrained from entering the groove.

This means that based on the basic mode, an application mode in which the tail has curved corrugated projections and depressions as the projections and depressions is preferable.

The long tail 133c and the projections and depressions 133c_2 of the embodiment correspond to one examples of the tail and the projections and depressions of the application mode.

In this embodiment, the long tail 133c is adhered and fixed to the groove 132a with the adhesive 170. With the adhering and fixing operation, sufficient strength for fixing can be obtained, the operation is very simple and in this embodiment, the efficiency of the assembling operation is enhanced by employing such adhering and fixing.

This means that based on the basic mode, the application mode having an adhesive which fixes the tail in the groove is preferable.

The adhesive 170 which fixes the long tail 133c into the groove 132a as illustrated in FIG. 2 corresponds to one example of the adhesive in the application mode.

In this embodiment, the adhesive 170 is applied to the edge of the groove 132a and the projections and depressions 133c_2 of the long tail 133c, and fixes the long tail 133c into the groove 132a. As a result, in this embodiment, the capillary action is effectively restrained by the projections and depressions 133c_2 and the long tail 133c is fixed.

This means that based on the application mode that the tail is fixed by means of the adhesive, an application mode in which the adhesive is applied to the edge of the groove and the projections and depressions of the tail, and the tail is fixed into the groove is further preferable.

The adhesive 170 of the embodiment corresponds to one example of the adhesive in the application mode.

As described above, according to the HDD 100 of the embodiment, the long tail 133c is fixed into the groove 132a of the arm 132 by means of the adhesive 170 in a state where the capillary action is effectively restrained and the non-cured adhesive 170 is restrained from entering. Therefore, according to the HDD 100 of the embodiment, when a deteriorated head 120 is replaced by new one in each suspension 133, it is easy to take the long tail 133c out from the groove 132a of the arm 132, and it is easy to replace the head 120 with a new one. In the HDD 100 of the embodiment, since non-cured adhesive 170 is restrained from entering the groove 132a, it is easy to remove the adhesive 170 from the groove 132a, and the head 120 can easily be replaced as well.

As described above, according to the HDD 100 of the embodiment, it is possible to easily replace the head 120.

Although the long tail 133c provided with the projections and depressions 133c_2 only at one position which passes through the groove 132a of the arm 132, on the opposite edge of the arm 132 is illustrated as one example of the tail in the basic mode and the application mode, the tail of the basic mode and the application mode is not limited to this. In the tail, the projections and depressions may be provided on a wide range of the edge beyond the portion that pass through the groove, or may be provided at each position of the edge that passes through the groove of the arm, carrying out the adhering and fixing operations at each of the projections and depressions.

The long tail 133c having curved corrugated projections and depressions was illustrated as one example of the tail in the basic mode and the application mode, the tail of the basic mode and the application mode is not limited to this. This tail may be provided with, for example, rectangular projections and depressions or sawtooth projections and depressions.

In the basic mode of the head arm assembly, the leaf spring and the tail constitute the long tail type suspension. A position halfway across the tail is mounted in the groove, and projections and depressions are provided in the widthwise direction on the opposite edge of the arm. As a result, a surface area of the position mounted in the groove becomes wider due to the projections and depressions. A simple way of mounting this position into the groove is to use an adhesive. According to the basic mode of the head arm assembly, capillary action generated between the mounting position of the tail and the inner walls of the groove is restrained by great surface tension caused by the surface area widened by the projections and depressions at the time of fixing, and non-cured adhesive is restrained from entering. Therefore, according to the basic mode of the head arm assembly, it is easy to take out the mounted tail from the groove, and the head can be replaced by a new one in each suspension composed of the leaf spring and the tail. According to the basic mode of the head arm assembly, since non-cured adhesive is restrained from entering, it is easy to remove the adhesive from the groove, and the head can be replaced easily as well.

As described above, according to the present invention, it is possible to easily replace a head.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made here to without departing from the spirit and scope of the invention.

What is claimed is:

1. A head arm assembly comprising:
a slider which has a head executing recording and/or reproducing operations of information onto and/or from an information recording medium, and which approaches or comes into contact with the information recording medium,
a leaf spring which holds the slider at its one end,
an arm which holds the other end of the leaf spring and is provided with a groove at a predetermined position, and
a tail which extends from the leaf spring in a form of a band, which is provided with a conductive pattern connected to the head along the band, in which a halfway position of the band in a longitudinal direction is mounted in the groove of the arm, one of both edges at the position is directed toward the arm, and the tail has projections and depressions in a widthwise direction of the band on an edge opposite to the arm at the position.

2. The head arm assembly according to claim 1, wherein the tail has curved corrugated projections and depressions as the projections and depressions.

3. The head arm assembly according to claim 1, wherein the arm has a groove deeper than a width of the tail as the groove.

4. The head arm assembly according to claim 1, further comprising an adhesive which fixes the tail into the groove.

5. The head arm assembly according to claim 4, wherein the adhesive is applied to the edge of the groove and the projections and depressions of the tail, and fixes the tail into the groove.

6. An information storage device comprising:
an information recording medium,
a slider which has a head executing recording and/or reproducing operations of information onto and/or from the information recording medium, and which approaches or comes into contact with the information recording medium,
a leaf spring which holds the slider at its one end,
an arm which holds the other end of the leaf spring and is provided with a groove at a predetermined position, and
a tail which extends from the leaf spring in a form of a band, which is provided with a conductive pattern connected to the head along the band, in which a halfway position of the band in a longitudinal direction is mounted in the groove of the arm, one of both edges at the position is directed toward the arm, and the tail has projections and depressions in a widthwise direction of the band on an edge opposite to the arm at the position.

7. The information storage device according to claim 6, wherein the tail has curved corrugated projections and depressions as the projections and depressions.

8. The information storage device according to claim 6, wherein the arm has a groove deeper than a width of the tail as the groove.

9. The information storage device according to claim 6, further comprising an adhesive which fixes the tail into the groove.

10. The information storage device according to claim 9, wherein the adhesive is applied to the edge of the groove and the projections and depressions of the tail, and fixes the tail into the groove.

11. A suspension comprising:
a slider which has a head executing recording and/or reproducing operations of information onto and/or from an information recording medium, and which approaches or comes into contact with the information recording medium,
a leaf spring which holds the slider at its one end,
an arm which holds the other end of the leaf spring, and
a tail which extends from the leaf spring in a form of a band, which is provided with a conductive pattern connected to the head along the band, in which a halfway position of the band in a longitudinal direction is mounted in the groove of the arm, one of both edges at the position is directed toward the arm, and the tail has projections and depressions in a widthwise direction of the band on an edge opposite to the arm at the position.

12. The suspension according to claim 11, wherein the tail has curved corrugated projections and depressions as the projections and depressions.

13. The suspension according to claim 11, wherein the arm has a groove deeper than a width of the tail as the groove.

14. The suspension according to claim 11, further comprising an adhesive which fixes the tail into the groove.

15. The suspension according to claim 14, wherein the adhesive is applied to the edge of the groove and the projections and depressions of the tail, and fixes the tail into the groove.
